(19) United States
(12) Patent Application Publication
(10) Pub. No.: US 2014/0001219 A1
(43) Pub. Date: Jan. 2, 2014

(54) TABLET-STYLE PC HANGING MOUNT

(71) Applicant: Joshua MILLER, Portage, MI (US)

(72) Inventor: Joshua MILLER, Portage, MI (US)

(73) Assignee: Service Solutions U.S. LLC, Wilmington, DE (US)

(21) Appl. No.: 13/538,580

(22) Filed: Jun. 29, 2012

(51) Int. Cl. B60R 7/04; B23P 11/00

(52) U.S. Cl. 224/553; 224/555; 29/428; 29/434

(57) ABSTRACT

A tablet support is provided. In some embodiments the tablet support includes: legs; hook supports located at an end of each leg; a support strap configured to form a loop over a support member; and a fastener attaching the support strap to the legs. A method of assembling a tablet support may be provided. The method may include: providing a support loop; equipping a support strap with the support loop; attaching support legs to the support strap; terminating the support legs with hooks; and attaching a fastening structure on the support strap.

### FIELD OF THE INVENTION

The present invention relates generally to the method and apparatus for holding a tablet device. More particularly, the present invention relates to a support for holding a tablet device inside a vehicle.

### BACKGROUND OF THE INVENTION

Tablet devices, such as Tablet-Style PCs, iPads or other similar devices are being use for an increased variety of tasks. For example, one task that tablets can be used for is in performing diagnostics on a vehicle such as an automobile. While performing such a task, it may be desirable to attach the tablet device inside the vehicle in such a way that a technician can view the screen, input data and otherwise access the tablet device. It may be desirable to attach the tablet device to a fixed support inside the vehicle.

Currently, there are no known support devices or apparatuses that allow a technician to attach a tablet device to the interior of the vehicle while the tablet device is used for diagnostic functions of the vehicle. In some instances, it may be desirable to attach the tablet to a fixed support such as a steering wheel or other portions of the vehicle.

Accordingly, it is desirable to provide a method and apparatus that allows a technician to attach a tablet device to an interior support in a vehicle.

### SUMMARY OF THE INVENTION

The foregoing needs are met, to a great extent, by the present invention, wherein in one aspect an apparatus is provided that in some embodiments a method and apparatus is provided that allows a technician to fix a tablet device to a support within the vehicle such as, for example, a steering wheel.

In accordance with one embodiment of the present invention, a tablet support is provided. In some embodiments the tablet support includes: legs; hook supports located at an end of each leg; a support strap configured to form a loop over a support member; and a fastener attaching the support strap to the legs.

In accordance with another embodiment of the present invention, a method of assembling a tablet support may be provided. The method may include: providing a support loop; equipping a support strap with the support loop; attaching support legs to the support strap; terminating the support legs with hooks; and attaching a fastening structure on the support strap.

In accordance with yet another embodiment of the present invention, a tablet support may be provided. The tablet support may include: legs; means for support located at an end of each leg; means for flexible supporting configured to form a loop over a support; and means for fastening attaching the means for flexible supporting to the legs.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a tablet-style PC hanger.

FIG. 2 is a perspective view of the tablet-style PC hanger.

FIG. 3 is a front view of a tablet-style PC hanger attached to a steering wheel within a vehicle.

FIG. 4 is a front view of a PC tablet-style hanger attached to a steering wheel and supporting a PC style tablet device.

### DETAILED DESCRIPTION

An embodiment of the invention will now be described with reference to the drawing figures, in which like reference numerals refer to like parts throughout. An embodiment in accordance with the present invention provides a hanger for a tablet-style PC.

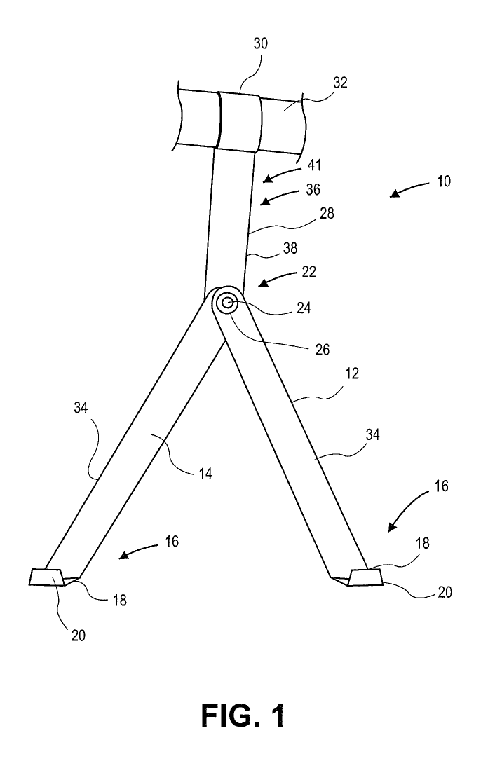

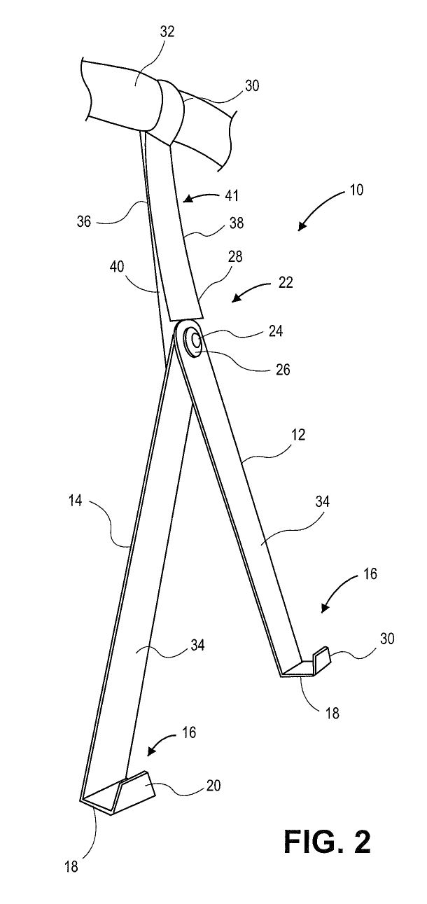

As shown in FIGS. 1 and 2, a hanger 10 in accordance with some embodiments of the invention is illustrated. The hanger 10 includes legs 12 and 14. The legs 12 and 14 include a supporting portion 16. The supporting portion 16 is dimensioned to provide support for a tablet-style PC computer, such as an iPad or other tablet devices.

The supporting portion 16 includes a bottom portion 18 and an up turned portion 20. The bottom portion 18 provides support for the tablet-style device whereas the up turned portion 20 helps to keep the tablet-style device in place on the bottom portion 18.

The legs are joined at a joint 22, which allows the legs 12 and 14 in some embodiments to pivot. The joint 22 may include a fastener 24 and a washer 26.

The fastener 24 attaches the legs 12 and 14 to a strap 28. In some embodiments of the invention, the strap 28 may be a flexible. The strap 28 may be a woven nylon strap 28. The strap 28 may be made of a variety of materials in accordance with some embodiments of the invention.

The fastener 24 may include a nut and bolt system used in conjunction with a washer 26 to attach the legs 12 and 14 to the strap 28. In other embodiments of the invention, the fastener 24 may include a rivet or any other suitable fastener.

In accordance with some embodiments of the invention, the joint 28 allows the legs 12 and 14 to pivot to move from side to side so that the legs 12 and 14 are a desired space apart in order to provide stable support for a tablet-style device.

The strap 28 may form a loop 30. The loop 30 is designed to loop over a support member 32. The support member 32 may be any structure that may be able to be wrapped around by the strap 28 and has sufficient strength to support the hanger 10 and tablet device supported by the hanger 10.

In some embodiments of the invention, the legs 12 and 14 may have a resilient coating 34. The resilient coating 34 may be rubber or any other sort of resilient coating to protect a finish on a tablet device from being marred by contact with the legs 12 and 14.

In some embodiments of the invention, the legs 12 and 14 themselves may be made of aluminum, plastic, nylon or any other suitable substance. In some embodiments of the invention, it may preferable that the legs 12 and 14 may be made of a rigid material as opposed to a flexible materials, such as that used to make the a strap 28.

As seen in FIGS. 1 and 2, the hanger 10 may hang by the support member 32. The support member 32 is not part of the hanger 10, but in merely an environmental structure by which the hanger 10 may hang. The user may take the strap 28 and form a loop 30 and loop the strap 28 around itself. This may be done, for example, by use of a hook and loop attaching device 36 such as Velcro.

In accordance with some embodiments of the invention, one of the hook or loop portions of the attaching device 36 may be located on one side of the loop 30 and the other of the hook and loop attaching device 36 may be located on the other side of the loop 30. The loop 30 is formed from two ends of the strap 28 as shown in FIGS. 1 and 2. The hook and loop attaching device 36 on each end attach to each other. The loop 30 may also be adjusted according to the needs of an individual situation.

In some embodiments of the invention, the front portion of the strap 38 attaches to the back portion of the strap 30 as described above to form the loop 30 while the hook and loop attaching device 36 has been described. Other fastening type systems may also be used, such as snaps or any other suitable fastening type system.

In some embodiments in accordance with the invention, the front portion 38 of the strap 28 may include an advertising portion 41. The advertising portion 41 may be located on the front portion of the strap 38 and may include advertising that may be stitched into the front portion of the strap 38 may be stamped, painted or any other method of marking indicia upon the advertising potion 41 of the strap 28.

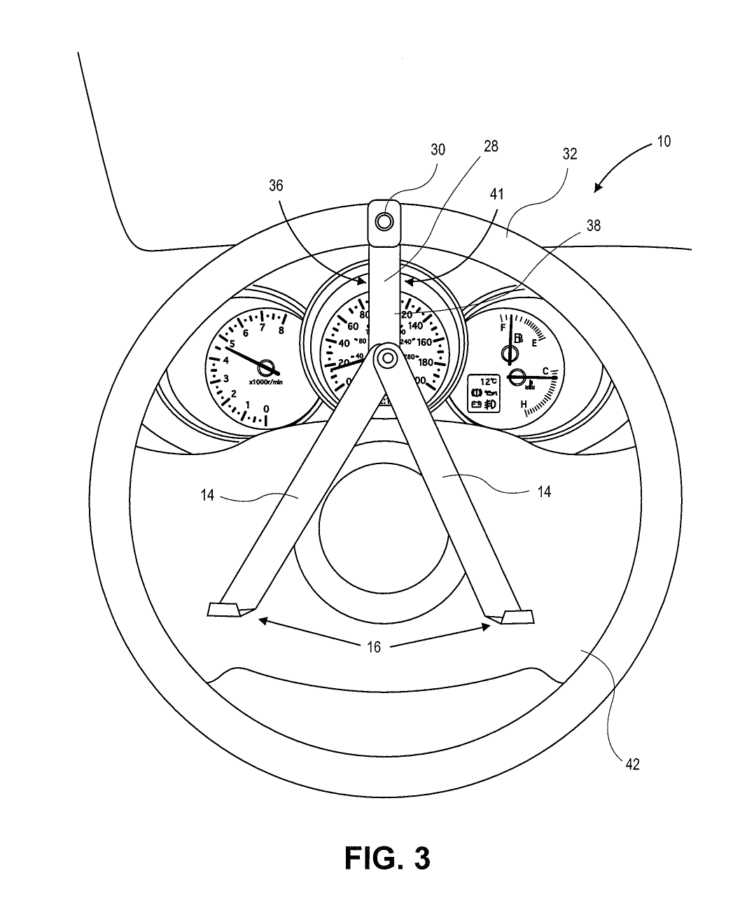

FIG. 3 illustrates the hanger 10 attached to support member 32. In this instance, the support member 32 is a steering wheel of a vehicle. The loop 30 of the strap 28 has been looped around the steering wheel support member 32. The front portion 38 of the strap 28 is shown along with the advertising portion 41, and the hook and loop attaching device 36. The legs 12 and 14 are shown in a spread apart position and the supporting portions 16 are also illustrated. The cross members of the steering wheel 42 are located to be behind the legs 12 and 14 to add additional stability support to the hanger 10 to assist the hanger 10 to not swing back and forth.

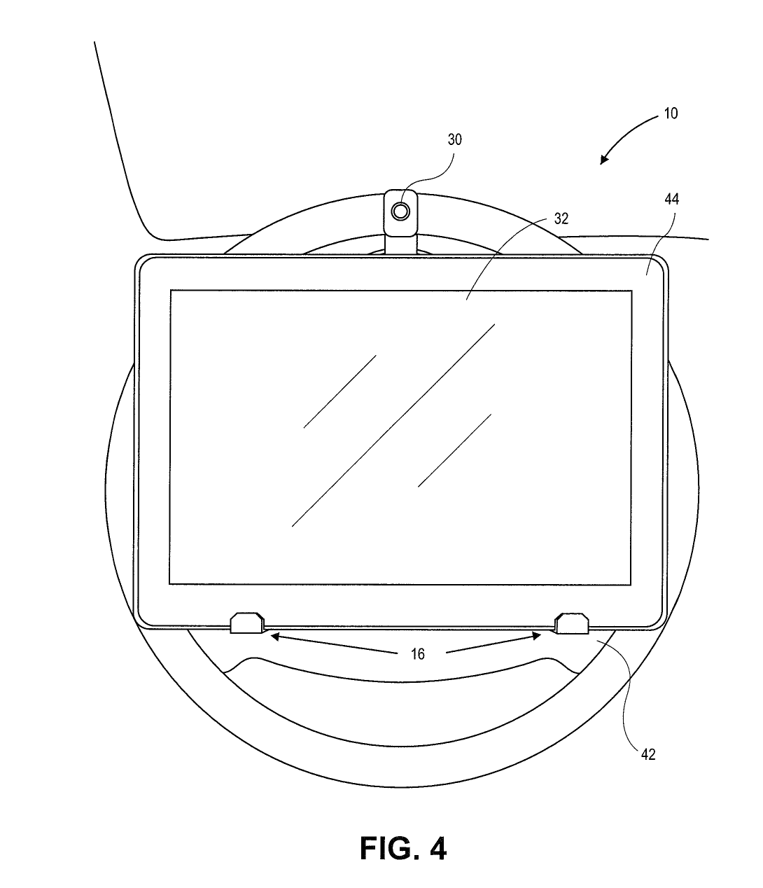

FIG. 4 illustrates the hanger 10 supporting a tablet device 44. As shown in FIG. 4, the supporting portions 16 support the tablet device 44. The tablet device 44 is also partially supported or at least positioned by the cross members of the steering wheel 42 (best shown in FIG. 3). The loop 30 is looped around the support member 32 which is, in this instance, a steering wheel. The tablet device 44 is now supported and positioned so that a user may use the tablet device to perform diagnostic functions of the vehicle or any other function of the vehicle. The tablet device 44 is secured by the hanger 10 in a convenient manner for a technician and allows the technician to use the tablet device 44 for a variety of features while performing maintenance or diagnostics on the vehicle.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A tablet support comprising:
legs;
hook supports located at an end of each leg;
a support strap configured to form a loop over a support member; and
a fastener attaching the support strap to the legs.

2. The tablet support of claim 1, wherein the legs are pivotally movable about the fastener.

3. The tablet support of claim 1, wherein the hooks have a resilient outer surface.

4. The tablet support of claim 1, further comprising a hook and loop fastening system located on the support strap.

5. The tablet support of claim 4, wherein one of a hook portion of the hook and loop fastening system and a loop portion is located on a portion of the strap on one side of the loop and the other of the hook portion and loop portion is located on the other side of the loop.

6. The tablet support of claim 1, wherein the legs, and hook supports are dimensioned to attach to and support a tablet.

7. The tablet support of claim 1, wherein the fastener includes a washer.

8. The tablet support of claim 1, wherein the strap contains an advertising section.

9. The tablet support of claim 8, wherein the advertising includes stitching.

10. The tablet support of claim 1, wherein the fastener includes snaps.

11. The tablet support of claim 1, wherein the fastener is a rivet.

12. The tablet support of claim 1, wherein the legs are aluminum.

13. A method of assembling a tablet support comprising:
providing a support loop;
equipping a support strap with the support loop;
attaching support legs to the support strap;
terminating the support legs with hooks; and
attaching a fastening structure on the support strap.

14. The method of claim 13, wherein the fastening structure includes a hook and loop fastening system.

15. The method of claim 13, wherein the legs are pivotally attached to the strap.

16. The method of claim 13, wherein the support loop is adjustable.

17. The method of claim 13, further comprising adding advertising to the support strap.

18. The method of claim 13, further comprising adding a resilient outer surface to the hooks.

19. The method of claim 13, wherein the tablet support is dimensioned to support a tablet.

20. A tablet support comprising:
legs;
means for support located at an end of each leg;
means for flexible supporting configured to form a loop over a support; and
means for fastening attaching the means for flexible supporting to the legs.
